(19) United States
(12) Patent Application Publication
(10) Pub. No.: US 2004/0215743 A1
(43) Pub. Date: Oct. 28, 2004

(54) Mouse synchronization for virtual presence architecture (VPA)

(75) Inventors: Colin N.B. Cook, Riverton, UT (US); Warren K. Unice, Sandy, UT (US)

Correspondence Address: Davidson Berquist, Klima & Jackson LLP, Suite 920, 4501 North Fairfax Drive, Arlington, VA, 22203, US

(73) Assignee: Soronti, Inc.

(21) Appl. No.: 10/792,662

(22) Filed: Mar. 4, 2004

Related U.S. Application Data
(60) Provisional application No. 60/452,276, filed on Mar. 4, 2003.

(51) Int. Cl. G06F 15/16; H04M 11/00

(52) U.S. Cl. 709/217; 709/219; 379/93.01

(57) ABSTRACT

A method and system is disclosed for perfecting the images generated by a KVM switch. Video signals generated by a host computer are transmitted to a client computer in order to allow the user of a client computer to have a virtual presence on the host computer. However, the signals transmitted by the host computer may contain errors that would impair the client user's ability to remotely control the host computer. Therefore this virtual presence architecture uses phase locked loops to compare screen data that is being sent to the client and removes errors so that the user data is properly transmitted and displayed.

This application claims priority of U.S. Provisional Patent Application Ser. No. 60/452,276 filed Mar. 4, 2003, which is hereby fully incorporated by reference.

### FIELD OF THE INVENTION

This invention generally relates to the field of remote computer access. More specifically, an exemplary embodiment of the present invention relates to virtual presence architectures and methods of synchronizing a client computer's mouse with a host computer's mouse.

### BACKGROUND OF THE INVENTION

It is often the case that a host computer is located physically distant from its operator. Some products have been created to facilitate remote control of a computer using devices that remotely project the keyboard, video and mouse. These are typically called keyboard-video-mouse (KVM) devices. Examples include:

1. KVM Switch: Enables a single keyboard, mouse and video display to be shared by multiple computers;

2. KVM remote: Enables a keyboard, mouse and video display to be viewed remotely, with typically several hundred feet of separation;

3. Remote Control Software: Enables a computer to “take over” a remote computer and use the local machine to provide keyboard and mouse input, and video output over a network; and

4. Specialized hardware components that interact with proprietary software to provide remote KVM functionality over a network.

Each of these approaches has disadvantages sometimes associated with the software configurations of the hosts that may differ significantly from machine to machine. For example, when using a virtual presence architecture, it is possible that the host computer's mouse and the client computer's mouse may become out of sync. This problem may occur due to errors in the operating system of one of the respective computers or might result from a data transmission error. Therefore, it is desirable to have a method of automatically synchronizing the movements of a local mouse on a client computer with the movements of a remote mouse on a host computer.

### BRIEF SUMMARY OF THE INVENTION

The present invention, which may be implemented utilizing a general-purpose digital computer, in certain embodiments of the present invention, includes novel methods and apparatus to provide efficient, effective, and/or flexible use of existing local area network (LAN) infrastructure for remote control of host computers, without requiring significant reconfiguration of the computer software and/or hardware.

One embodiment of the present invention includes an architecture that provides remote control of a host computer over existing Internet protocol (IP) network infrastructure without requiring significant changes to the remote host, but allows deployment with different levels of intrusiveness (e.g., depending on the requirements of the application). The Virtual Presence Architecture (VPA) is comprised in part by a host computer, a Virtual Presence Client (VPC), and a Virtual Presence Server (VPS). The host computer can output signals directly to the VPC or VPS, depending on the architecture's configuration. The VPC and VPS then act in conjunction with each other to display the video of the host computer's signals on a remote computer.

In another embodiment of the present invention, the mouse signals of the client computer and the host computer are synchronized. This embodiment can be implemented in both automatic and user-operated modes. For example, the VPC might detect that the mouse movements of the local user are no longer in sync with the mouse movements on the remote host computer. In one embodiment of the invention, the VPC could automatically synchronize both mice. In another embodiment of the invention, the user can periodically choose to synchronize the client mouse and the host mouse. In a further embodiment of the invention, the VPC could prompt the user to synchronize the client mouse and the host mouse if it detects that they are no longer synchronized.

### BRIEF DESCRIPTION OF THE DRAWINGS

FIG. 1 is a block diagram of an exemplary system into which virtual presence architecture may be implemented.

FIG. 2 is an exemplary block diagram of a virtual presence architecture.

FIG. 3 is a more detailed block diagram of a virtual presence architecture.

FIG. 4 is a block diagram indicating data flow in a virtual presence architecture.

### DETAILED DESCRIPTION OF THE INVENTION

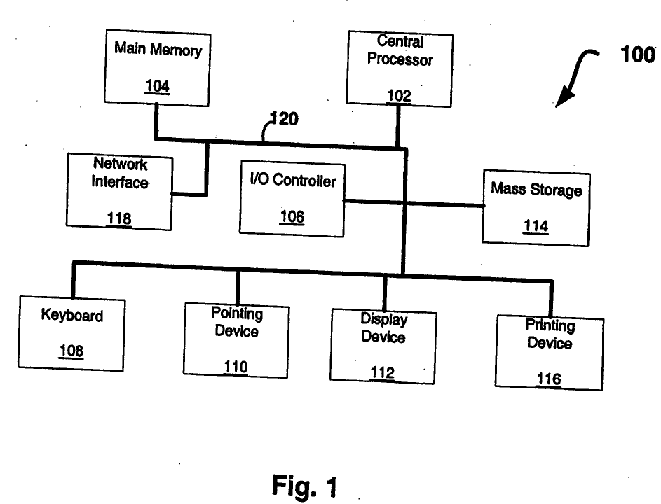

FIG. 1 shows the basic format where the Video Presence Architecture (VPA) may be implemented. The computer system 100 comprises a central processor 102, a main memory 104, an input/output (I/O) controller 106, a keyboard 108, a pointing device 110 (e.g. mouse, track ball, stylus, or the like), a display device 112, a mass storage 114 (e.g. hard disk, optical drive, or the like), and a network interface 118. Additional I/O devices, such as printing device 116, may be included in the computer system 100 as desired.

The system also comprises system bus 120, or similar architecture through which some or all of the components shown communicate with each other. Additionally, those with ordinary skill in the art will recognize that computer system 100 can include an IBM-compatible personal computer utilizing an Intel microprocessor, or any other type of computer. Additionally, instead of a single processor, two or more processors can be utilized to provide faster operations.

The network interface 118 provides communication capability with other computer systems on the same local network, on a different network connected via modems and the like to the present network, or to other computers across the Internet. In various embodiments, the network interface 118 can be implemented in Ethernet, Fast Ethernet, Gigabit Ethernet, wide-area network (WAN), leased line (such as T1, T3, optical carrier 3 (OC3), and the like), digital subscriber line (DSL and its varieties, such as high bit-rate DSL (HDSL), integrated services digital network DSL (IDSL) and the like), time division multiplexing (TDM), asynchronous transfer mode (ATM), satellite, cable modem, Universal Serial Bus (USB) and FireWire.

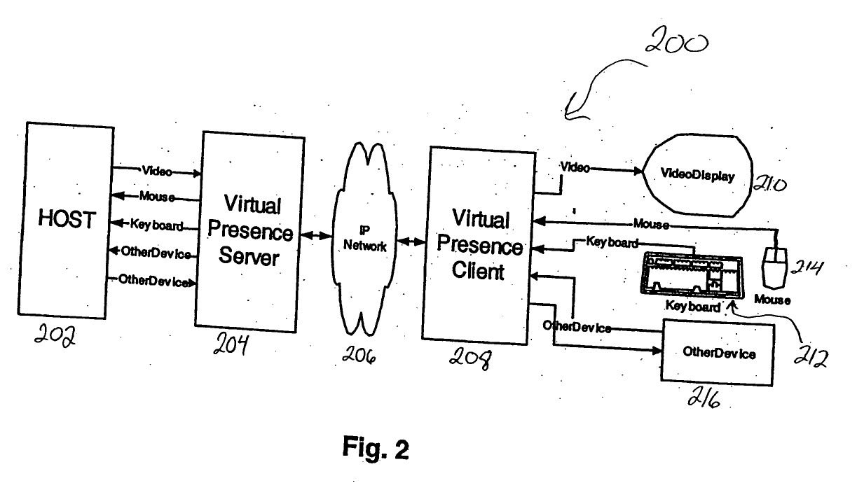

FIG. 2 illustrates an exemplary block diagram of a Virtual Presence Architecture (VPA) in accordance with an embodiment of the present invention.

Table 1 below provides a glossary of the terms used to describe the VPA architecture in accordance with some embodiments of the present invention (such as those discussed with respect to Figs. herein).

TABLE 1
Glossary of Terms

| TERM | GLOSSARY |
|---|---|
| Capture | The process of digitizing and formatting data for |
| | processing. |
| Decode | Decode: the process of converting data encoded, e.g., by |
| | a virtual presence encoder for a device into a form |
| | suitable for transfer to that device. |
| Encode | The process of converting signals captured for a device |
| | into a form suitable for transfer to, e.g. a virtual presence |
| | decoder. |
| Host | The remote computer that is to be controlled form the |
| | local client. |
| NIC | Network interface connection, i.e., the device that |
| | provides network connectivity. |
| VPC | Virtual presence client; the subsystem that captures |
| | keyboard, mouse and other local device inputs for |
| | transmission to the VPS, and decodes the video display |
| | and other outputs from the VPS |
| VPP | Virtual presence protocol; the syntax and semantics of |
| | the messages exchanged by the VPS and the VPC. The |
| | VPP may be implemented on transmission control |
| | protocol (TCP) and user datagram protocol (UDP) over |
| | IP in an embodiment of the present invention |
| VPS | virtual presence server; the subsystem that captures the |
| | hardware outputs of the host, encodes them for |
| | transmission to the VPC, and decodes the keyboard, |
| | mouse and other device inputs transmitted by the VPC; |
| Message | The entity that receives messages and tags them as being |
| Multiplexer | a particular type, then delivers them to be compressed |
| | and optionally encrypted. |
| Message | The entity that takes decrypted and decompressed data |
| Demultiplexer | from the stream and delivers it to the receiver registered |
| | to get that message type. |
| Frame Buffer | Memory where the digital image of the screen is stored; |
| | in an embodiment of the present invention, it consists of |
| | 16 bit pixels with 5 bits each for Red, Green and Blue |
| | intensity. |
| Tile | 256 pixel area of the frame buffer treated as a unity by |
| | the video subsystem in accordance with an embodiment |
| | of the present invention. |

In FIG. 2, the VPA 200 includes a Virtual Presence Server (VPS) 204 co-located with the remote host 202 and a Virtual Presence Client (VPC) 208 at a location remote from the VPS. The host 202 interacts with the devices connected to the VPC (such as video display 210, keyboard 212, mouse 214, and other device 216) as if they were connected directly to host 202. In one embodiment of the present invention, an advantage of this approach is the flexibility in the design and deployment of the VPS 204.

FIG. 2 further demonstrates that keyboard 212, mouse 214, other device 216 send their respective signals to the VPC 208. VPC 208 captures the hardware outputs of the host and encodes them for transmission to the VPS. The transmission to the VPS can take place over IP Network 206, which is connected to host computer 202. Following transmission, the signals arrive in VPS 204, which decodes the keyboard, mouse and other device inputs transmitted by the VPC. These inputs are then sent to the host computer, where the input commands are executed. Following the execution of the keyboard, mouse and other device commands, host 202 sends a hardware output in the form of a video signal displaying changes resulting from the input commands and a signal for the other device 216. The VPS 204 captures the hardware outputs and encodes them for transmission to the VPC 208 over IP Network 206. VPC 208 then decodes the video and other device outputs from the VPS and transmits them to either video display 210 or other device 216.

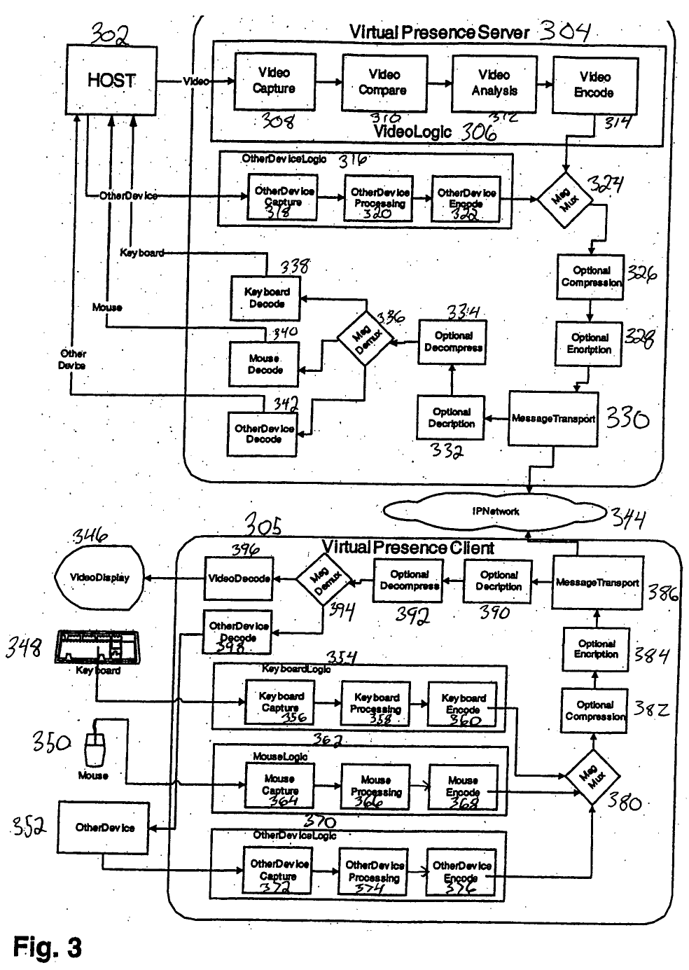

FIG. 3 illustrates a more detailed block diagram of a VPA in accordance with another embodiment of the present invention. Here, VPC 305 accepts signals from keyboard 348, mouse 350, and other device 352. These signals are then input to Keyboard Logic 354, Mouse Logic 362, and Other Device Logic 370, respectively. Inside each of the logic devices, the respective signals are captured at steps 356, 364, and 372, respectively, and are digitized and formatted for processing at steps 358, 366, and 374, respectively. After processing, the signals are encoded at steps 360, 368, and 376, respectively, by converting the captured signals for each device into forms suitable for transfer to a decoder, such as a Virtual Presence decoder. After the signals are encoded, they are sent to multiplexer 380, which combines the keyboard, mouse and other device signals in preparation for transmission to the VPS 304. However, before transmission, the signals can optionally be compressed in step 382 and/or encrypted in step 384. Then the signals are transported in 386 via IP network 344 to the VPS 304.

Once in VPS 304, the signals are decrypted and decompressed in items 332 and 334, respectively, if required. The input signals are then demultiplexed in 336 in order to separate the signals for decoding in items 338, 340, and 342. Then the keyboard, mouse and other device signals are sent to the host 302, where the commands are executed internally. Following the execution of the keyboard, mouse and other device inputs, two hardware output signals are transmitted back to VPS 302, the video output signal and the other device output signal. The video output signal enters Video Logic element 306, which captures, compares, analyzes and encodes the output in steps 308-314, respectively. The other device output signal is sent to Other Device Logic element 316, where it is captured, processed and encoded in steps 318-322, respectively. The encoded video and other device outputs are then multiplexed in step 324, and can optionally be compressed and/or encrypted in steps 326 and 328, respectively.

The multiplexed output signal is then transported in step 330 over IP Network 344 to the VPC 305. Once the output signal is back in the VPC, it is decrypted and decompressed, if need be, in steps 390 and 392, respectively. The output signal is then demultiplexed into separate video and other device signals in step 394. Following that, the two signals are decoded in steps 396 and 398, and then sent to video display 346 and other device 352, where the outputs are displayed to the remote user. For example, the video output signal of host 302 is displayed on video display 346, and the other device output signal is executed on other device 352.

In another embodiment of the present invention, the devices in the VPA can be characterized by their data flow requirements. For example, the video logic system 306 on the VPS captures video frames, does delta analysis and encodes the stream for the VPC to decode and display. This does not require any return information in accordance with an embodiment of the present invention. Similarly, the mouse and keyboard subsystems may simply transmit the stream from their corresponding devices on the VPC for transmission to the VPS. On the other hand, special devices such as USB may require bi-directional transfers which are treated as independent directional flows by the architecture.

In a further embodiment of the present invention, the VPS captures video and transmits it to the VPC. For example, the VPS receives the mouse and keyboard data streams from the VPC and decodes them into signals for the Host. The VPS manages input and output data streams for other devices and simulates the local interactions necessary to provide remote functionality.

In accordance with another embodiment of the present invention, the keyboard and mouse may both be simple byte streams. Therefore, there would be little processing necessary to decode the streams. However, there is significant processing to maintain synchronization and duplicate the semantics and timing of the streams so that the Host can properly maintain its states as if the devices were directly connected.

More specifically, in an embodiment of the present invention, the VPS keyboard subsystem relays the byte stream from the remote keyboard to the Host without any additional processing. In a further embodiment, the VPS mouse subsystem relays the byte stream from the remote mouse to the Host. This byte stream may include “delta” messages (e.g. indicating change), which are interpreted by the Host relative to the current position of the cursor. Due to timing and other issues, the relative position of the cursor can get out of sync. Consequently, special processing in both the VPS and VPC can be used to mitigate this problem.

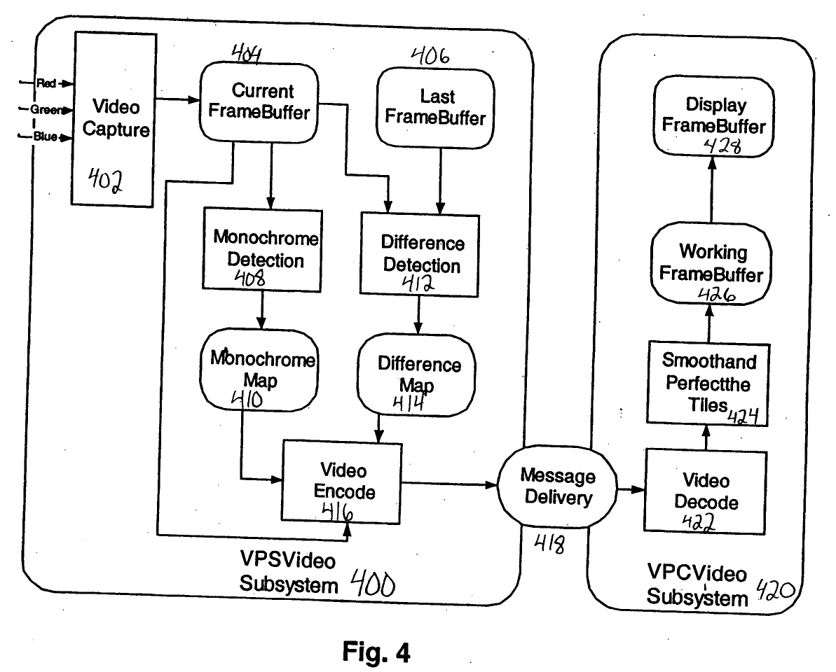

FIG. 4 illustrates an exemplary flow for the VPS and VPC video subsystems in accordance with an embodiment of the present invention. Since video is often the most data intensive part of the Virtual Presence system, the most significant processing occurs in this component. VPS Video subsystem 400 captures the red, green and blue (RGB) video signals outputted from a host computer in step 402. The RGB signals are then transmitted to Current Frame Buffer 404. The illustrated video subsystem may be implemented in accordance with two characteristics of a computer's video display (such as the system discussed with respect to FIG. 1). Because screens may be primarily one color and because the screen typically only changes in local areas, leaving most of the display the same, the Video subsystem can take advantage of these characteristics to provide significant reductions in the required data.

In an embodiment of the present invention, the VPS video logic may specifically benefit from the creation of custom hardware to support the process. In another embodiment of the present invention, a field-programmable gate-array (FPGA) may be utilized to implement the logic in hardware. Further information regarding an FPGA apparatus for a VPA is later described in detail.

For example, in one embodiment, the video may be first captured into one of two frame buffers that alternate between being the current frame buffer 404 and the last frame buffer 406. In the present embodiment, the frame buffer is divided into “tiles” of 256 pixels. The Monochrome detection logic 408 analyzes each tile to see if its pixels are within a specified difference in color. If they are, then the Monochrome Map 410 corresponding to that tile receives a 1; otherwise, it receives a 0. The Difference Detection logic 412 compares each pixel in the Current frame buffer 404 with the corresponding pixel in the Last frame buffer 406. If more than a specified number of pixels have changed, then the bit corresponding to this tile is set to one in the Difference Map 414; otherwise it is set to zero.

In accordance with another embodiment of the present invention, the video encoder 416 then processes the two maps minimizing the data transmitted to indicate which tiles are changed, and sending a “raw” tile or a “monochrome” tile or a “no change” tile, and using, for example, run-length encoding to eliminate duplicates. The encoded stream is then passed to the message delivery subsystem 418 for optional compression and encryption, and then transmission to the VPC 420.

In a further embodiment of the present invention, the VPC 420 captures keyboard and mouse data streams, encodes them, and transmits the streams to the VPS 400. The VPC 420 later receives an encoded video stream, decodes it in step 422, and then processes the stream to remove encoding artifacts in step 424. The VPC 420 then transfers the image to its own display, mapping the pixel image as needed. In particular, because the mouse is used as a pointing device and its motion is translated to a cursor on the video image, special processing may be utilized to keep the VPC cursor synchronized with the Host cursor.

Moreover, since the VPS 400 may have no access to information about the internal state of the host (e.g., if the host operating system does not operate in a deterministic manner on the given inputs), the host state may become out of sync with the VPC 420. In one particular example, Microsoft Windows operating systems periodically ignores mouse moves, which can cause a significant problem. Therefore, in one embodiment of the present invention, a control is provided on the VPC 420 that moves the logical mouse to a corner of the screen. This may be accomplished by sending a large quantity of relative movements that guarantee that the mouse has moved completely across the screen and to the top.

In a further embodiment of the present invention, the mouse may be automatically synchronized periodically. In particular, after a specified time or specified number of mouse movements have been transmitted, the VPC 420 computes the logical position of the mouse, which corresponds to where the cursor should be located on the host. In order to accomplish this, the VPC 420 then sends a stream of mouse-move messages similar to the embodiment described previously, insofar as it moves the mouse across the screen and to the top of the screen. Further, the mouse subsystem on the VPC 420, as well as 362 in FIG. 3, may send positioning movements to place the host mouse in the logical position computed on the client. Thus, the logical and actual host mouse positions can be synchronized transparently without the need for operator intervention.

In another embodiment of the present invention, the VPC encodes the byte stream from the local keyboard and delivers it to the message subsystem, which in turn optionally compresses and encrypts the stream, and then delivers it to the VPS. Keyboard processing is envisioned to be a simple direct transfer with no feedback between the VPS and VPC in accordance with an embodiment of the present invention. Also, the encoding includes aggregating mouse move messages and transmitting the aggregate. Additional processing may be performed by the mouse subsystem to keep the cursors synchronized as described above.

In another embodiment of the present invention, the VPC receives an encoded video stream from the VPS. The VPC decodes the stream into a working buffer, which it then processes to remove artifacts of the encoding algorithm used. Then, the working buffer is transmitted to the actual display buffer on the VPC, which the video hardware displays on the local display device.

It is envisioned that the architecture discussed herein may be implemented in many different ways. In various embodiments of the present invention, the Virtual Presence Architecture may be implemented utilizing the following techniques. A heavily pipelined application specific integrated circuit (ASIC) or FPGA may be used create the Tile Map and the Monochrome Map. Further, when compressing and sending large data blocks, the blocks may be divided, so they overlap (for example: compress some data, then send some data). Either DIB Section application programming interfaces (APIs) or DirectX can be used to access specialized hardware features without having to write hardware-specific code. Additionally, the extent of the changed area may be found and only update information for that area can be sent. Further, to speed up the process, the client may start the request for the next update area before it processes current area data, or the server may automatically prepare next update area. Also, if more than one Monochrome or No Change tile is present in the video encoder, they can be stacked together and sent as one count. Further, overlapping as many operations as possible that can happen in parallel can also reduce processing time. Additionally, when painting the monochrome tile on the client, blending its edges with surrounding area can reduce the amount of data sent. Next, for slower links, such as Dial-up or DSL, the packet turn around time can be relatively long, so one can modify any transport used to send long streams of packets and not spend time waiting for acknowledgements. Further, a compression function can be used that is balanced in time with the transport time (for example, one may avoid spending more time compressing than the bandwidth of the transport may easily handle). Also, the client code should be tuned to the native OS and CPU for best performance. Finally, for very slow transports, extra time can be spent to break up tiles into subsections, and reduce data (e.g., blend groups or pixels into one, or reduce to 8-bit color instead of 32-bit color, and the like).

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of remote situations, gaming and the like. Therefore, the object of the appended claims to cover all such variations and modifications as come within the spirit and scope of the invention.

1. A method of providing mouse synchronization in a virtual presence architecture, comprising:
after a predetermined condition is met, computing a logical position of the mouse with a virtual presence client (VPC), said logical position corresponding to a position where a cursor corresponding to the mouse should be located on a host video; and
sending a stream of move messages, wherein the logical and actual host mouse positions are synchronized without operator intervention.

2. The method of claim 1, wherein the predetermined condition is the occurrence of one of either a specified time or a specified number of mouse movements.

3. The method of claim 1, wherein the predetermined condition is the earlier of a specified time lapse or the occurrence of a specified number of mouse movements.

4. The method of claim 1, wherein a mouse subsystem on the VPC sends positioning movements to place a host mouse in the logical position computed on the VPC.

5. The method of claim 1, wherein the VPC automatically synchronizes the logical mouse position and the actual host mouse position.

6. The method of claim 4, wherein the mouse synchronization is transparent to the user of the remote computer.

7. The method of claim 4, wherein the mouse synchronization is enacted through the command of a user.

8. The method of claim 4, wherein the VPC prompts the user to perform mouse synchronization.

9. A virtual presence architecture (VPA) between a host computer and a remote computer, the remote computer having an associated mouse, comprising:
a virtual presence server communicating with the host computer;
a virtual presence client communicating with the remote computer;
wherein said virtual presence server (VPS) and said virtual presence client (VPC) communicate to allow remote access to said host computer; and
wherein said VPC computes a logical position of the mouse, which corresponds to where a cursor corresponding to the mouse should be located on said host.

10. The VPA of claim 9 wherein the virtual presence server is in a PCI card installed in a PCI slot of the host computer.

11. The VPA of claim 9, wherein the computing of the logical position of the mouse is used to synchronize a logical cursor to an actual cursor.

12. The VPA of claim 11, wherein the mouse synchronization is transparent to the user.

13. The VPA of claim 11 wherein the synchronization is performed automatically after a predetermined condition is met.

14. The VPA of claim 13, wherein the predetermined condition is an amount of time.

15. The VPA of claim 13, wherein the predetermined condition is a number of mouse moves.

16. The VPA of claim 9, wherein the user of said remote computer prompts the VPC to compute the logical position of the mouse.

17. A virtual presence architecture (VPA) for a host computer, comprising:
a virtual presence server;
a virtual presence client; and
means for computing a logical position of a mouse, which corresponds to where a cursor corresponding to the mouse should be located on a host.
